(19) United States
(12) Patent Application Publication
(10) Pub. No.: US 2015/0173509 A1
(43) Pub. Date: Jun. 25, 2015

(54) FURNITURE STRUCTURE

(71) Applicant: UNIFOR S.P.A., Turate, CO (IT)

(72) Inventors: Cesare Picchio, Turate (IT); Piero Molteni, Turate (IT)

(73) Assignee: UNIFOR S.P.A., Turate, CO (IT)

(21) Appl. No.: 14/405,879

(22) PCT Filed: Dec. 14, 2012
(86) PCT No.: PCT/IB2012/057309

§ 371 Date: Dec. 5, 2014

(30) Foreign Application Priority Data
Jun. 6, 2012 (IT) MI2012A000985

(51) Int. Cl. A47B 47/00; F16B 19/00; A47B 55/00; F16B 43/00

(52) U.S. Cl. CPC A47B 47/0091; F16B 43/00; F16B 19/00; A47B 55/00; A47B 47/0066

(57) ABSTRACT

A furniture structure (1) comprising at least one shoulder (2) and a back panel (6) connected to said shoulder (2), said shoulder comprising a surface opposite that of the back panel (6), wherein a decorative panel (30) is connected to at least said shoulder (2) in its surface opposite to that of the back panel (6), and wherein said shoulder comprises an embedding seat (31) which receives said decorative panel (30), by burying it flush with the seat edges, and wherein said decorative panel has a surface facing the shoulder which comprises at least one preferably blind seat (32), and said seat firmly receives a coupling pin (33) having a free end (34) and stop means for elastic means (35) fitted on said coupling pin to affect in pre-load an undercut supporting washer (36), wherein said pin (33) together with said washer (36) pre-loaded by said elastic means (35) are received in a decorative panel seat (37) provided in said shoulder (2) having an inlet opening (38) of a width capable of receiving the pin (33) and the washer (36), said opening (38) continuing with a panel coupling slit (39) suitable to allow the stem of said coupling pin (33) to slide, but capable of preventing the escape of the undercut supporting washer (36) that, when inserted in said seat (37), elastically affects said decorative panel (30) abutting against the shoulder (2), and connecting the panel (30) to the shoulder, hiding each joining means from view, and avoiding the need for permanent fixing means, such as glue or welding, wherein said decorative panel is preferably but not necessarily a slab of marble (30).

### FIELD OF THE INVENTION

The present invention refers to a furniture structure.

In particular, the present invention refers to a furniture structure such as, for example, a bookcase, in particular a metal structure capable of withstanding even heavy loads while continuing to have an aesthetically pleasant appearance.

More in particular, the present invention refers to a modular furniture structure, obtained by assembling different units and suitable to be dismantled and reassembled quickly when re-arranging the layout of the furniture in the rooms of a building, for example a building used by the public, such as a library.

For this reason, there is a strong need for furniture structures that are robust while at the same time able to substantially hide the structural elements used to join the various units from the user's view.

In particular, there is a strong need for a furniture structure, for example a bookcase with shelves, that is simple to make and assemble, but which at the same time is robust and capable of bearing decorative elements that may be as heavy as or even heavier than the actual furniture structure itself.

More in particular, there is a strong need for a furniture structure in which the use of coupling elements between the parts, such as screws, bolts and above all glue and welding, is reduced to a minimum.

Even more in particular, there is a strong need for a large furniture structure that is easily adaptable as a function of the construction tolerances of the components thereof or of the surface on which it stands or which can adapt to wide temperature ranges and the relative deformations of the actual structure.

### PRIOR ART

Document GB 900215 A by VERNON CARLOS JACK BLAKE describes a metal box-shaped structure for use as a bookshelf bay, for example in a library. However, said structure is not suitable for bearing shelves or decorative panels.

Document JP 55139135 A also describes a box-shaped furniture structure made of folded sheet metal. However, also in this case the proposed structure is not particularly suitable for bearing heavy loads.

Document EP 0 426 051 B1 by KYORAKU CO. LTD. describes a box-shaped furniture structure in which walls, a base and a back panel are joined to form a bay. Also in this case not all the joints are hidden from view and above all the structure is not suitable for heavy loads.

Document JP 2009-101097 by KOKUYO KK describes a box-shaped structure with walls that are thin yet suitable for creating a robust assembly.

### Solution

The purpose of the present invention is therefore to provide a furniture structure that satisfies the aforesaid needs and at the same time overcomes the drawbacks of the prior art solutions mentioned above.

Said problem is overcome with a furniture structure as claimed in appended claim 1 and a method for assembling a furniture structure as claimed in appended claim 8.

According to a general embodiment of the invention, a furniture structure comprises at least one shoulder having a shoulder body with a preset height. Said shoulder body has at least one wall which delimits said shoulder body. Said shoulder body comprises at least one shoulder slit forming an opening through said at least one wall, said opening having a preset longitudinal dimension and a preset transverse dimension or width.

Said furniture structure further comprises a back panel having a substantially plate-shaped back panel body of a preset thickness transverse in relation to said plate-shaped back panel. Said back panel body comprises at least one back panel edge suitable to cooperate with said at least one shoulder to form said furniture structure.

According to one embodiment of the invention, said back panel edge has at least one tenon portion or tenon comprising a tenon neck and a tenon projection. According to one embodiment of the invention, said tenon neck has a preset neck dimension, transverse in relation to said plate-shaped back panel body. Said tenon projection has a tenon projection dimension, transverse in relation to the plate-shaped back panel body, that is greater than said preset back panel thickness.

According to one embodiment, said tenon projection has a tenon projection dimension, transverse in relation to the plate-shaped back panel body, greater than said neck dimension.

According to one embodiment, said at least one back panel tenon is inserted into said shoulder slit by arranging its tenon neck astride said at least one shoulder body wall and bringing said tenon projection in undercut with respect to the back panel body.

In accordance with a further general embodiment of the invention, a furniture structure comprises a decorative panel that is connected to at least one furniture shoulder in its surface opposite to that of the shoulder that is connected to a back panel. Said shoulder comprises an embedding seat which receives said decorative panel, by burying it flush with the seat edges.

According to one embodiment of the invention, said decorative panel has a surface facing the shoulder which comprises at least one preferably blind seat, and said seat firmly receives a coupling pin having a free end and stop means for elastic means fitted on said coupling pin to affect in pre-load an undercut supporting washer.

According to one embodiment of the invention, said pin together with said washer pre-loaded by said elastic means are received in a decorative panel seat provided in said shoulder, having an inlet opening of a width capable of receiving the pin and the washer. According to one embodiment of the invention, said opening continues with a panel coupling slit suitable to allow the stem of said coupling pin to slide, but capable of preventing the escape of the undercut supporting washer that, when inserted into said seat, elastically affects said decorative panel abutting against the shoulder and connecting the panel to the shoulder, hiding each joining means from view, and avoiding the need for permanent fixing means, such as glue or welding.

According to one embodiment of the invention, said decorative panel is, for example, a sheet of marble.

The solutions described above make it possible to obtain an extremely robust structure which is also adaptable as a function of specific operating conditions, construction tolerances or changing environmental temperatures.

In particular, with the solutions described above the furniture structure can be adapted according to the construction tolerances of the back panel and the extrudates or box-shaped elements that form the shoulders or the covering structure.

The allowance for clearance in the joints between the tenon and the check block seat means that it is possible to compensate for out-of-flatness of the supporting surface even in the case of extremely long furniture structures, or deformations due to thermal expansion of the components of the structure, or deformations due to heavy loads placed on the structure.

The proposed solution is particularly suitable for use as book shelving in a library, or cabinets in an office.

### FIGURES

Further characteristics and advantages of the furniture structure according to the invention will become clear from the following description of some non-limiting embodiments thereof, provided merely by way of example, and with reference to the accompanying drawings, in which:

FIG. 1 is a perspective view of an assembly comprising a plurality of furniture structures;

FIG. 2 is a perspective view of a step in the assembly of a furniture structure and in particular the step of joining a back panel to a shoulder;

FIG. 3 illustrates a cross-section of a furniture structure, in which the shoulder has been cut to show an enlarged view of the top only, where it supports a covering element, a hook of a pair of overlapping shelves and the base where joined to the base structure;

FIG. 4 is a cross-sectional view of a shoulder with details of parts of the coupling of the back panel, the connection of the base structure and the height-adjustable feet;

FIG. 5 is a longitudinal cross-section of a pair of furniture structures joined together by means of a common shoulder, the base structures and the covering elements, and the coupling of the two back panels to the same shoulder;

FIG. 6 is a perspective view of a detail of a shoulder and of a coupling between a back panel and its tenon in undercut with the block seat of a check block inserted into a hollow structure of the shoulder;

FIG. 7 is a perspective view illustrating a detail of the base of a shoulder at the point where it is provided with a height-adjustable foot and a base structure is firmly joined to the base of the shoulder;

FIG. 8 is a perspective view of a detail of the back of a decorative panel, in this case a slab of marble, with blind seats into which coupling pins fitted with an undercut supporting washer pre-loaded by elastic means are inserted;

FIG. 9 is a perspective view of a detail of an end shoulder with its external surface opposite to that for coupling to the back panel in which there are obtained decorative panel seats provided with seat inlet openings for the pin and washer and a panel coupling slit to allow the coupling pin stem to slide and prevent it from escaping;

FIG. 10 is a front view of a detail of the decorative panel, with blind seats into which is inserted a coupling pin with undercut supporting washer pre-loaded by elastic means when fitted on the wall of the shoulder;

FIG. 11 is a side view of the detail shown in FIG. 10;

FIG. 12 is a cross-sectional view in correspondence to the axis of the pin of the part shown in FIG. 10;

FIGS. 13 to 23 are schematic perspective views of different steps in the assembly and adjustment of a plurality of furniture structures to form a bookcase with shelves which, in particular, for each furniture structure, consist of first placing a shoulder in position, then of coupling a back panel by inserting in undercut the back panel tenon into the shoulder slit and optionally into the check block seat, then of coupling the base structure, then of coupling the opposite shoulder, then starting over again until all the furniture structure modules have been joined and lastly of coupling the covering structures and then adjusting the height of the feet supporting the shoulders, mounting some of the shelves leaving the base accessible, wiring the furniture structure assembly to connect the power supply, for example to any lighting fixtures, and then assembling the last shelves, possibly after adjusting the height of the shoulder feet again;

FIG. 24 is a perspective view of a detail of the insertion of a back panel tenon in undercut in a block seat, showing the clearance between the parts.

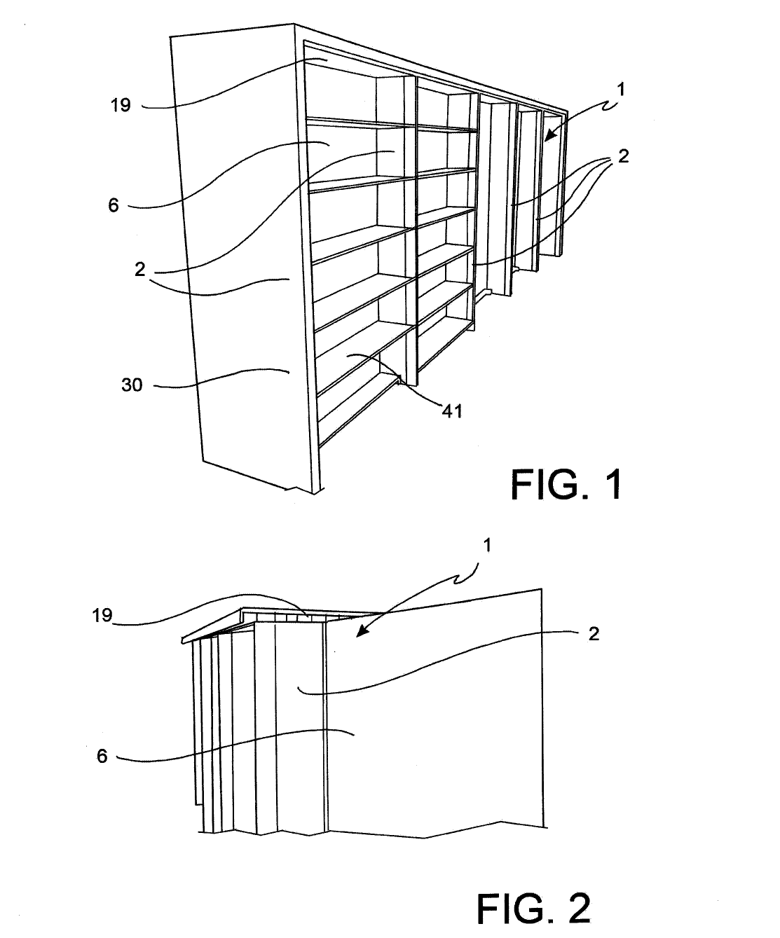

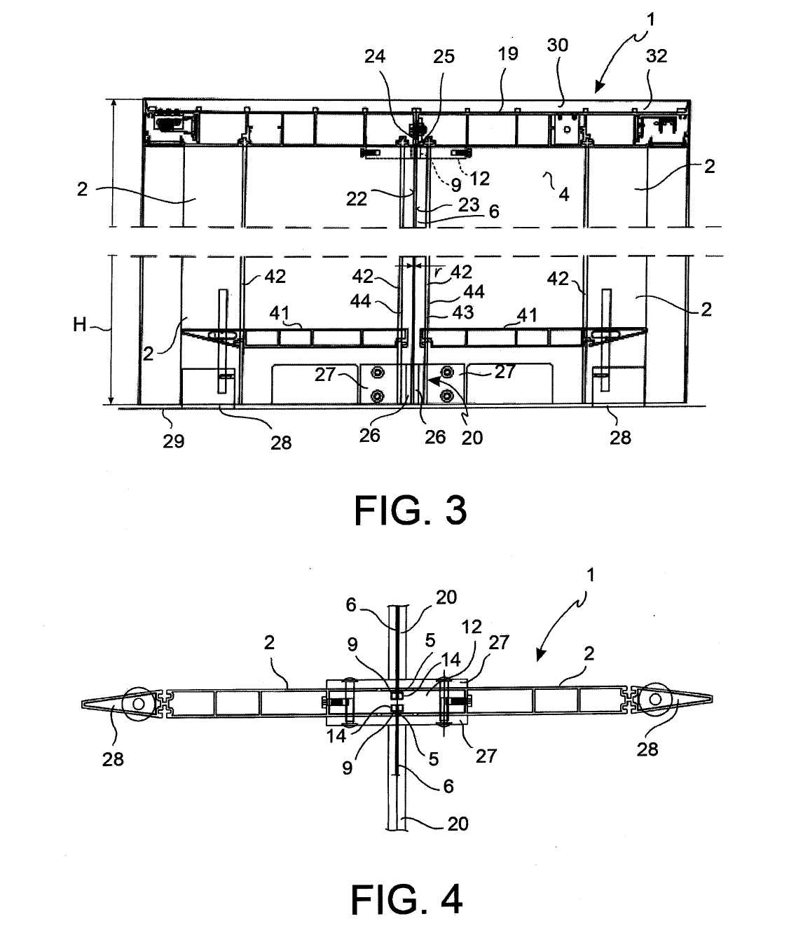

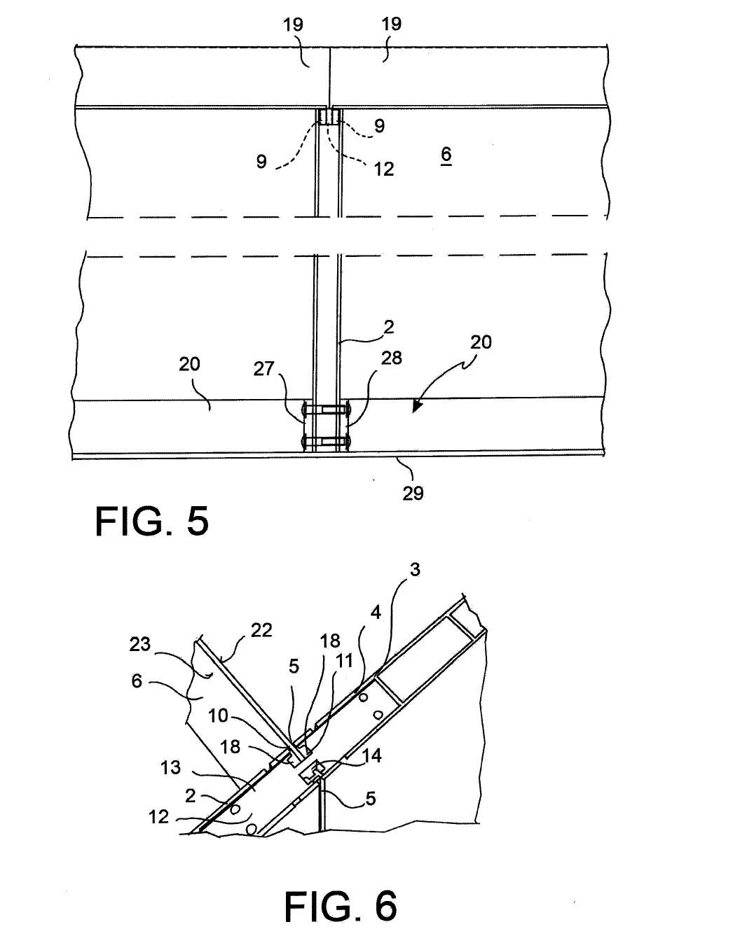

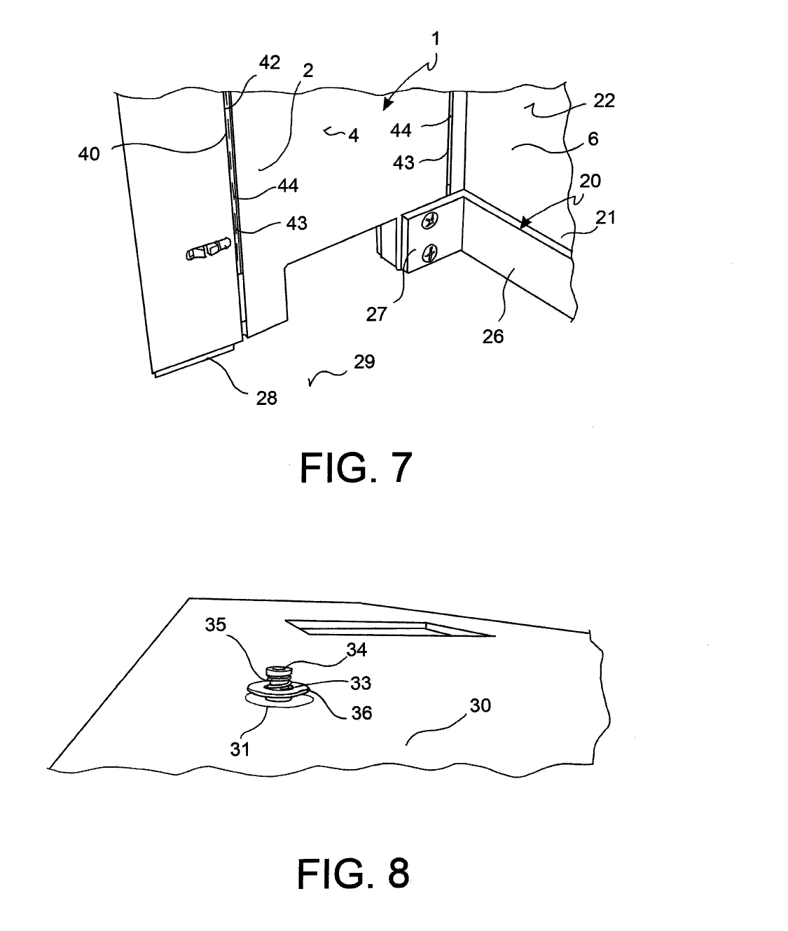

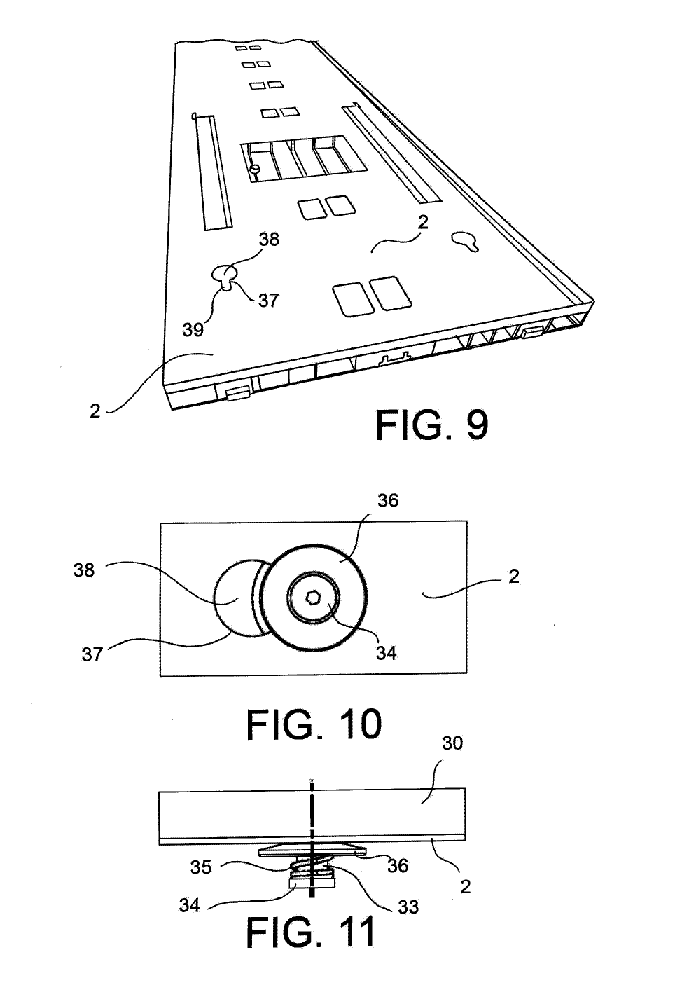

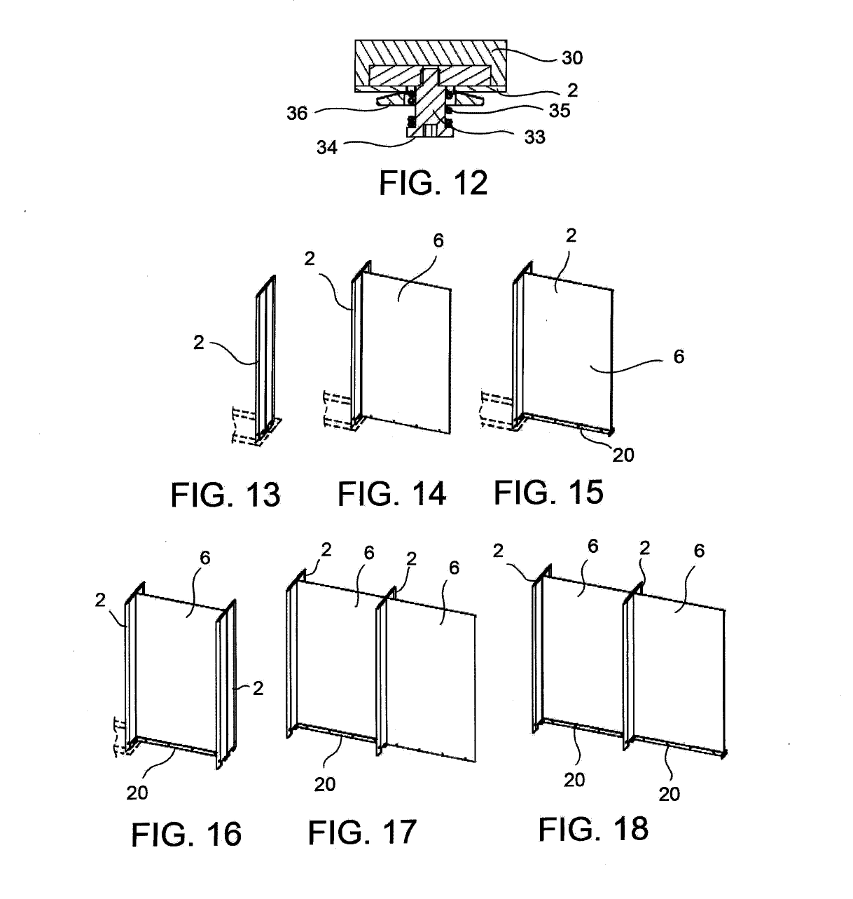

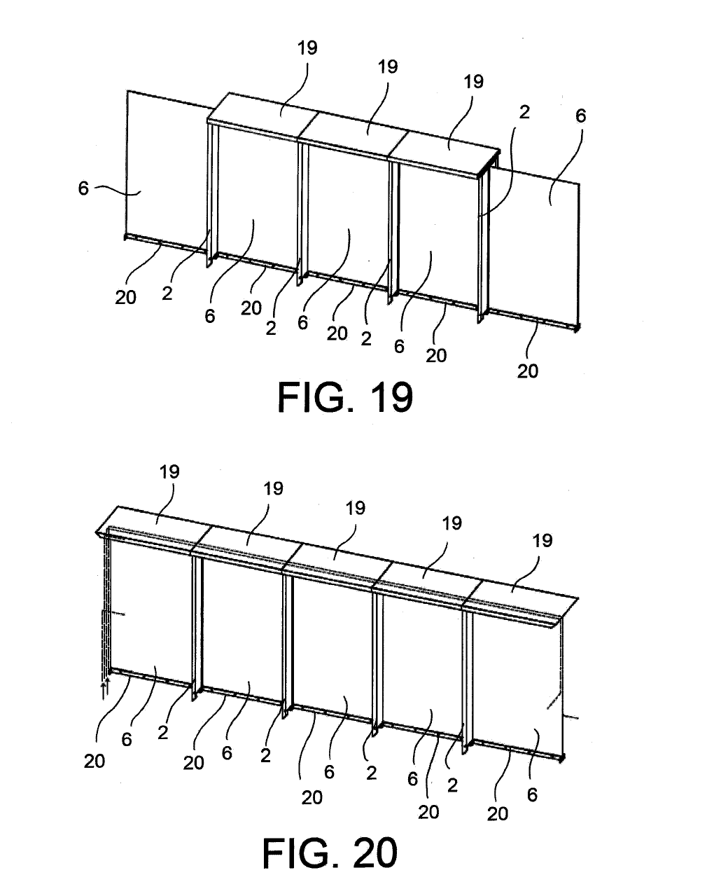

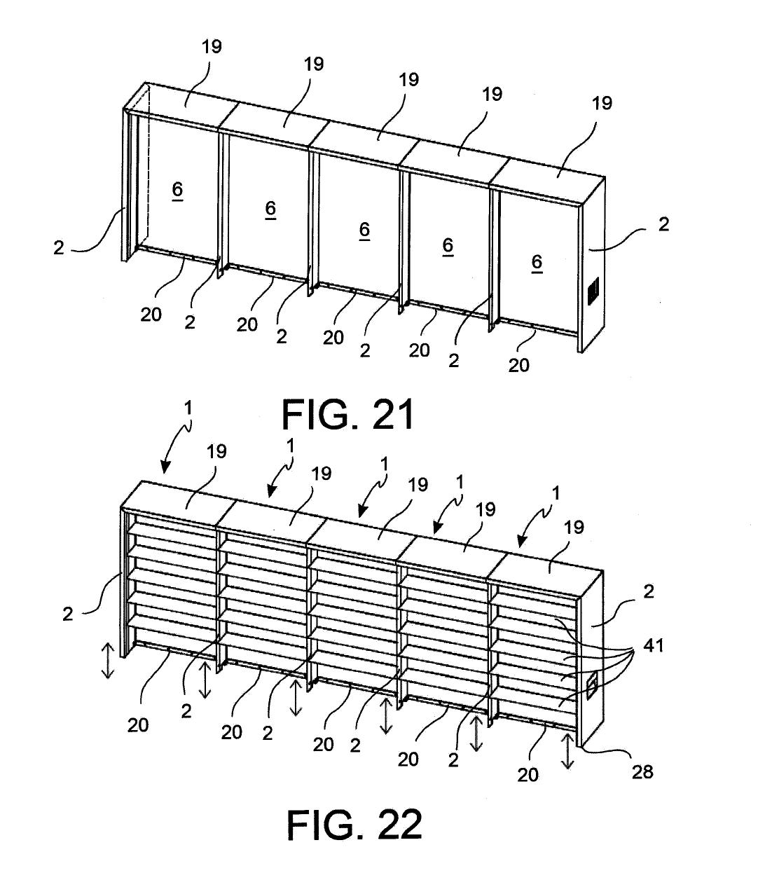

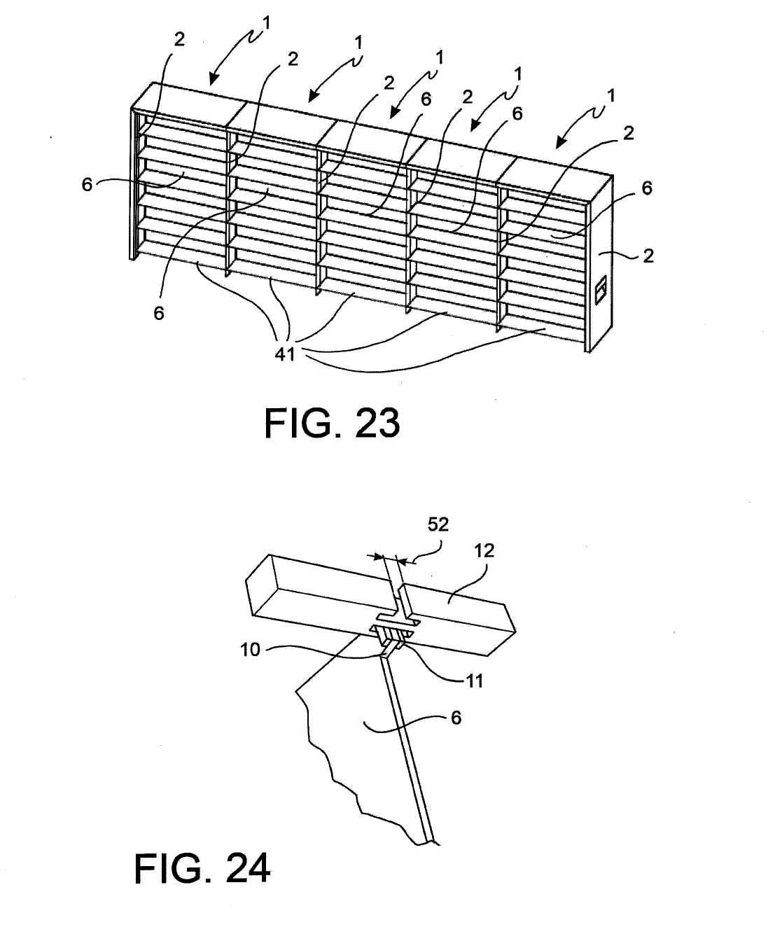

### DESCRIPTION OF SOME PREFERRED EMBODIMENTS OF THE INVENTION

With reference to the aforesaid figures and according to a general embodiment of the invention, a furniture structure 1 comprises at least one shoulder 2 having a shoulder body 3 of a preset height H.

Said shoulder body 3 has at least one wall 4 which delimits said shoulder body 3. Said shoulder body 3 comprises at least one shoulder slit 5 forming an opening through said at least one wall 4 having a preset longitudinal dimension and a preset transversal dimension or width, indicated by reference numeral “s1”.

According to one embodiment of the invention, said furniture structure 1 further comprises a back panel 6 which has a substantially plate-shaped back panel body 7 having a preset thickness “r” transverse in relation to said plate-shaped back panel body 7. According to one embodiment of the invention, said back panel body 7 comprises at least one back panel edge 8 suitable to cooperate with said at least one shoulder 2 to form said furniture structure 1.

According to one embodiment of the invention, said back panel edge 8 has at least one tenon portion or tenon 9 comprising a tenon neck 10 and a tenon projection 11.

According to one embodiment of the invention, said tenon neck 10 has a preset neck dimension “s”, transverse in relation to said plate-shaped back panel body 7.

According to one embodiment of the invention, said tenon projection 11 has a tenon projection dimension R″, transverse in relation to the plate-shaped back panel body 7, greater than said preset neck dimension “r”.

According to one embodiment of the invention, said tenon projection 11 has a tenon projection dimension R″, transverse in relation to the plate-shaped back panel body 7, greater than said neck dimension “s”.

According to one embodiment of the invention, said at least one back panel tenon 9 is inserted into said shoulder slit 5 by arranging its tenon neck 10 astride said at least one shoulder body wall 4 and bringing said tenon projection 11 in undercut with respect to the back panel body 7.

According to one embodiment of the invention, the furniture structure 1 further comprises a check block 12 having a check block body 13 that forms a block seat 14. According to one embodiment of the invention, said block seat 14 comprises a block slot 15 facing outwards from the check block 12. Said block slot 15 has a transverse dimension “s2” substantially equal to the width “s1” of the shoulder slit 5. According to one embodiment of the invention, said block seat further comprises an undercut block space 16 having a transverse dimension of the space “s3” greater than said block slot 15 transverse dimension.

According to one embodiment of the invention, said check block 12 is joined to said shoulder 2 so as to make said) block slot 15 aligned with and face said shoulder slit 5 from the opposite side to the at least one shoulder body wall 5 with respect to the back panel body 7 to receive a portion of said tenon neck 10 in said block slot 15 and to receive said tenon projection 11 in said undercut block space 16 to join said back panel 6 to said shoulder 2.

According to one embodiment of the invention, said tenon projection 11 has a tenon projection dimension R″, transverse in relation to the plate-shaped back panel body 7, greater than the transverse dimension “s2” of said block slot 15.

According to one embodiment of the invention, said tenon neck 11 is received in said shoulder slit 5 of said at least one shoulder body wall 4 with a clearance.

According to one embodiment of the invention, said tenon neck 11 is received in said block slot 15 of said block seat 16 with a clearance.

According to one embodiment of the invention, said tenon projection 11 is received in said undercut block space 16 with a clearance.

According to one embodiment of the invention, said shoulder slit 5 extends across the entire shoulder height “H” of said shoulder 2.

According to one embodiment of the invention, said back panel edge 8 of said back panel body 7 geometrically couples with a clearance with said shoulder slit 5 across its entire length.

According to one embodiment of the invention, said back panel tenon 9 is formed by a back panel plate-shaped body projection 17 to which at least two tenon blocks 18 are firmly secured, for example by welding, and on opposite sides.

According to one embodiment of the invention, said back panel body 7 is obtained from a plate, for example made of metal, for example made of steel or steel alloy, by laser cutting.

According to one embodiment of the invention, said shoulder 2 is made of a first material, said back panel 6 is made of a second material, and said check block 12 is made of a third material.

According to one embodiment of the invention, said back panel 6 and said check block 12 are made of the same material.

According to one embodiment of the invention, said shoulder 2 is made of aluminium or an aluminium alloy, said back panel 6 is made of steel or a steel alloy and said check block 12 is made of steel or a steel alloy.

According to one embodiment of the invention, a furniture structure 1 comprises two opposite shoulders 2 that are identical or specular to one another, suitable to couple with an interposed back panel 6 to form a furniture structure nodule.

According to one embodiment of the invention, a base structure 20 is comprised, arranged at the bottom and to firmly connect the base of said opposite shoulders 2 to form a furniture structure module.

According to one embodiment of the invention, said pack panel body 7 has at least one second back panel edge 21, substantially orthogonal to said back panel edge 8 cooperating with the shoulder 2, which is arranged at the bottom of said pack panel 6.

According to one embodiment of the invention, said back panel body 7 has at least a third back panel edge 25, substantially orthogonal to said back panel edge 8 cooperating with the shoulder 2, which is arranged at the top of said back panel 6.

According to one embodiment of the invention, said second back panel edge 21 is delimited by opposite back panel plate surfaces 22, 23. According to one embodiment of the invention, said base structure 20 cooperates with said second back panel edge 21 to tighten and closely press said opposite back panel plate surfaces 22, 23.

According to one embodiment of the invention, said base structure 20 comprises at least one pair of base beams 26 having prevailing length and folded ends 27. Said beam 26 rests on and tightens and presses closely the back panel 6, with the opposite beam arranged on the opposite side of the back panel, and firmly connects with its beam ends 27 to the shoulder 2.

According to one embodiment of the invention, said back panel 6, with its back panel tenons 9 arranged to extend the superiorly arranged third back panel edge 25, connects with said opposite shoulders 2 and said opposite shoulders 2 are mutually connected in the proximity of their base through said base beams 26, thus forming a superiorly and inferiorly closed modular structure.

According to one embodiment of the invention, said furniture structure 1 further comprises a cover structure 19, supported by said shoulders 2.

According to one embodiment of the invention, said structure has a longitudinal cover seat 24.

According to one embodiment of the invention, said third back panel edge 25 is delimited by opposite back panel plate surfaces 22, 23 and said cover structure 19 cooperates with said third back panel edge 25, which is at least partially received in said longitudinal cover seat 24.

According to one embodiment of the invention, said shoulder 2 is manufactured as a hollow box-shaped structure, for example as an extrudate or a plurality of mutually connected extrudates. According to one embodiment of the invention, said check block 12 is received in said hollow structure, hiding the connection with the back panel tenon 9 from view.

According to one embodiment of the invention, the shoulder 2 comprises at least one foot 28, adjustably extending from the shoulder 2 in order to adjust the height of the shoulder 2 from a supporting plane 29, for example a floor of a building.

According to one embodiment of the invention, each shoulder 2 comprises at least two feet 28 adjustably extending from the shoulder 2. According to one embodiment of the invention, said at least two feet 28 are arranged at the opposite ends of the shoulder base 2 and can be adjusted to raise the shoulder, and, therewith, the entire furniture structure 1 from the supporting plane 29, for example to compensate for construction tolerances or deformations due to the load supported by the furniture structure, or thermal deformations of the furniture structure.

According to a general embodiment of the invention, a furniture structure 1 comprises a decorative panel 30 connected to at least one shoulder 2 in its surface opposite to the back panel 6.

According to one embodiment of the invention, said shoulder comprises an embedding seat 31 which receives said decorative panel 30 by burying it flush with the edges of the embedding seat 31.

According to one embodiment of the invention, said decorative panel has a surface facing the shoulder or back, comprising at least one preferably blind seat 32.

According to one embodiment of the invention, in said seat a coupling pin 33 is firmly received, having a free end 34 and stop means for elastic means 35 fitted on said coupling pin to affect in pre-load an undercut supporting washer 36. According to one embodiment of the invention, said pin 33, together with said washer 36 pre-loaded by said elastic means 35 are received in a decorative panel seat 37 provided in a wall of said shoulder 2. Said decorative panel seat 37 having an inlet opening 38 of a width capable of receiving the pin 33 and the washer 36. According to one embodiment of the invention, said opening 38 continues with a panel coupling slit 39 suitable to allow the stem of said coupling pin 33 to slide, but preventing the escape of the undercut supporting washer 36 that, when inserted into said seat 37, elastically affects said decorative panel 30 abutting against the shoulder 2 and connecting the panel 30 to the shoulder 2 hiding all of the coupling means from view, thus avoiding the use of permanent fixing means, such as glue or welding.

According to one embodiment of the invention, said decorative panel is, for example, a slab of marble.

According to a general embodiment of the invention, the shoulder 2 comprises at least a series of anchoring means 40 of support hooks for shelves 41.

According to one embodiment of the invention, said anchoring means 40 comprise a rack received in a track 42 within the shoulder 2 but facing with rack anchoring loops 43 a track slot 44 through which support hooks for shelves 41 are inserted and are coupled with said anchoring loops 43 to support a shelf 41 at the preset height.

According to one embodiment of the invention, a pair of opposite shoulders 2, clamped by a back panel 6 and a base structure 20, form a structure of a bookcase to which a plurality of shelves or ledges 41 are coupled 41.

According to one embodiment of the invention, said back panel is made of steel plate having a thickness ranging from between 1 mm and 4 mm, preferably 2 mm.

According to one embodiment of the invention, said check block 12 is made of steel and forms a block seat with a height ranging from between 20 mm and 700 mm, preferably between 30 and 100 mm, to receive, in undercut the tenon projection 11 of the back panel 6.

The steps in a method of assembling a furniture structure will now be described. Said method comprises the following steps:
providing a furniture structure 1 as described above;
vertically arranging a shoulder 2 on a supporting plane 29;
fitting a back panel tenon 9 in undercut in a shoulder slit 5.

According to one embodiment of the invention, said method comprises the further steps of:
at least partially inserting a back panel edge 8 in a shoulder slit 5.

According to one embodiment of the invention, said method comprises the further steps of:
arranging a second opposite shoulder 2 facing the first one and
fitting in undercut an opposite back panel tenon 9 provided at the opposite end of the back panel 6 in a shoulder slit 5 of the opposite shoulder 2.

According to one embodiment of the invention, said method comprises the further steps of:
at least partially inserting an opposite back panel edge 8 in an opposite shoulder slit 5 of the opposite shoulder 2.

According to one embodiment of the invention, said method comprises the further steps of:
before fitting in undercut the opposite back panel tenon 9 in the shoulder slit 5 of the opposite shoulder 2, connecting a base structure 20 to the base of the first shoulder 2, tightening and pressing closely the back panel 6.

According to one embodiment of the invention, said method comprises the further steps of:
connecting the opposite shoulder 2 to the opposite end of the base structure 20 and
resting a cover structure 19 on the opposite shoulders by fitting the longitudinal cover seat 24 on the back panel edge.

According to a general embodiment of the invention, said method of assembly comprises the steps of:
inserting the at least one coupling pin 33 and the undercut supporting washer 36 projecting from the rear of a decorative panel 30 into an inlet opening seat 38 of a decorative panel seat 37 provided in an end shoulder of a furniture structure;
coupling in undercut of the wall of a shoulder body 3 the supporting washer 36 by sliding the stem of the coupling pin along the panel coupling slit.

According to one embodiment of the invention, said method comprises the further steps of:
embedding the decorative panel 30 in the embedding seat 31 of the shoulder 2.

According to one embodiment of the invention, said method comprises the further steps of:
inserting the at least one coupling pin 33 and the undercut supporting washer 36 projecting from the rear of a decorative panel 30 into an inlet opening seat 38 of a decorative panel seat 37 provided in a cover structure of a furniture structure;
coupling in undercut of the wall of a cover structure body the supporting washer 36 by sliding the stem of the coupling pin along the panel coupling slit and
embedding the decorative panel 30 in the embedding seat of the cover structure.

It is clear that modifications and variations may be made to the furniture structure according to the invention by a person skilled in the art, according to different circumstances and requirements, without departing from the scope of the present invention as set forth in the appended claims.

REFERENCE NUMERALS

| | |
|---|---|
| 1 | furniture structure |
| 2 | shoulder |
| 3 | shoulder body |
| 4 | shoulder body wall |
| 5 | shoulder slit |
| 6 | back panel |
| 7 | back panel body |
| 8 | back panel edge |
| 9 | back panel tenon |
| 10 | tenon neck |
| 11 | tenon projection |
| 12 | check block |
| 13 | check block body |
| 14 | block seat |
| 15 | block slot |
| 16 | undercut block space |
| 17 | back panel body projection |
| 18 | tenon block |
| 19 | cover structure |
| 20 | base structure |
| 21 | second back panel edge |
| 22 | back panel plate surface |
| 23 | opposite back panel plate surface |
| 24 | longitudinal cover seat |
| 25 | third back panel edge |
| 26 | base beam |
| 27 | beam end |
| 28 | height-adjustable foot |
| 29 | supporting plane |
| 30 | decorative panel - stone - marble |
| 31 | embedding seat |
| 32 | decorative panel seat |
| 33 | coupling pin |
| 34 | free and stopping end |
| 35 | elastic means |
| 36 | undercut supporting washer |
| 37 | decorative panel seat |
| 38 | seat inlet opening |
| 39 | panel coupling slit |
| 40 | anchoring means for shelf support hooks |
| 41 | shelf |
| 42 | track for rack |
| 43 | anchoring loops |
| 44 | track slot |
| H | shoulder height |
| s1 | shoulder slit width |
| s2 | block slot width |
| s3 | undercut block space width |
| r | back panel width |
| s | tenon neck dimension |
| R | tenon projection dimension |

1. A furniture structure comprising at least one side structure and a back panel connected to said side structure, said side structure comprising a surface opposite to the back panel, wherein a decorative panel is connected to at least said side structure in its surface opposite to the back panel, and wherein said side structure comprises an embedding seat receiving said decorative panel by burying it flush with the seat edges, and wherein said decorative panel has a surface facing the side structure comprising at least one preferably blind seat, a coupling pin is firmly received in said seat, having a free end and stop means for elastic means fitted on said coupling pin to affect in pre-load an undercut supporting washer, with said washer preloaded by said elastic means are received in a seat for decorative panel provided in said side structure, having an inlet opening having a width capable of receiving the pin and the washer, said opening continuing with a panel coupling slit suitable to slide the stem of said coupling pin, but preventing the escape of the undercut supporting washer that, when inserted into said seat, elastically affects said decorative panel abutting against the side structure and connecting the decorative panel to the side structure, and hiding each connection means from view, avoiding the use of non-removable fixing means, such as glue or welding, wherein preferably, but not necessarily, said decorative panel is a marble plate.

2. The furniture structure, according to claim 1, comprising:
at least one side structure having a side structure body having a preset height (H), said side structure body having at least one wall defining said side structure body;
said side structure body comprising at least one side structure slit forming an opening through said at least one wall having a preset longitudinal dimension and a preset transverse dimension or width (s1);
said furniture structure further comprising a back panel having a substantially plate-shaped back panel body having a preset thickness (r) transverse in relation to said plate-shaped back panel body; said back panel body comprising at least one back panel edge suitable to cooperate with said at least one side structure to form said furniture structure; wherein
said back panel edge has at least one tenon portion or tenon comprising a tenon neck and a tenon projection;
and wherein said tenon neck has a preset neck dimension (s) transverse in relation to said plate-shaped back panel body;
and wherein said tenon projection has a tenon projection dimension (R) transverse in relation to the plate-shaped back panel body greater than said preset back panel thickness (r);
and wherein said tenon projection has a tenon projection dimension (R) transverse in relation to the plate-shaped back panel body greater than said neck dimension (s);
and wherein said at least one back panel tenon is inserted into said side structure slit by arranging its tenon neck astride said at least one side structure body wall and bringing said tenon projection in undercut with respect to the back panel body.

3. The furniture structure according to claim 1, further comprising a retaining block having a retaining block body that forms a block seat, said block seat comprising a block slot facing outwardly from the retaining block, said block slot having a transverse dimension substantially equal to the width of the side structure slit, said block seat further comprising an undercut block space having a transverse space dimension greater than said transverse dimension of the block slot, said retaining block being joined to said side structure so as to make said block slot aligned with and face said side structure slit from the opposite side to the at least one side structure body wall with respect to the back panel body to receive a portion of said tenon neck in said block slot and to receive said tenon projection in said undercut block space to join said back panel to said side structure, wherein said tenon projection has a tenon projection dimension (R) transverse in relation to the plate-shaped back panel body greater than said transverse dimension of the block slot, and/or
wherein said tenon neck is received in said side structure slit of said at least one side structure body wall with a clearance, and/or wherein
said tenon neck is received in said block slot of said block seat with a clearance, and/or wherein
said tenon projection is received in said undercut block space with a clearance, and/or wherein
said side structure slit extends across the entire side structure height (H) of said side structure, and/or wherein
said back panel edge of said back panel body geometrically couples with a clearance with said side structure slit across its entire length.

4. The furniture structure according to claim 1, wherein said back panel tenon is formed by a back panel plate-shaped body projection to which at least two tenon blocks are firmly secured, for example by welding, and on opposite sides, and/or wherein
said back panel body is obtained from a plate by laser cutting, and/or wherein
said side structure is made of a first material, said back panel is made of a second material, and said retaining block is made of a third material, and/or wherein
said back panel and said retaining block are made of the same material, and/or wherein said side structure is made of aluminium or an aluminium alloy, said back panel is made of steel or a steel alloy, and said retaining block is made of steel or a steel alloy.

5. The furniture structure according to claim 1, comprising two opposite side structures that are identical or specular to one another, suitable to couple with an interposed back panel, and/or wherein
a base structure arranged at the bottom and for a firm connection of the base of said opposite side structures is comprised, to form a furniture structure module, and/or wherein said back panel body has at least a second back panel edge substantially orthogonal to said back panel edge cooperating with the side structure, which is arranged at the bottom of said back panel; and/or wherein
said back panel body has at least a third back panel edge substantially orthogonal to said back panel edge cooperating with the side structure, which is arranged at the top of said back panel, and/or wherein
said second back panel edge is defined by opposite back panel plate surfaces, and wherein
said base structure cooperates with said second back panel edge by tightening and pressing closely said opposite back panel plate surfaces, and/or wherein said base structure comprises at least one pair of base beams having a prevailing length and folded ends, wherein said beam rests on and tightens and presses closely the back panel and firmly connects with its beam ends to the side structure, and/or wherein, said back panel, with its back panel tenons arranged to extend the superiorly arranged third back panel edge, connects with said opposite side structures, and said opposite side structures are mutually connected in the proximity of their base through said base beams, thus forming a superiorly and inferiorly closed structure, and/or wherein, said furniture structure further comprises a cover structure, supported by said side structures, said structure having a longitudinal cover seat, and/or wherein said third back panel edge is defined by opposite back panel plate surfaces, and wherein
said cover structure cooperates with said third back panel edge, which is at least partially received into said longitudinal cover seat, and/or wherein
said side structure is manufactured as a hollow box-shaped structure, for example as an extrudate or a plurality of mutually connected extrudates, and wherein said retaining block is received into said hollow structure, hiding the connection with the back panel tenon from view.

6. The furniture structure according to claim 1, wherein the side structure comprises at least one foot adjustably extending from the side structure in order to adjust the height of the side structure from a supporting plane, for example, a floor of a building, and/or wherein
each side structure comprises at least two feet adjustably extending from the side structure and/or wherein
said at least two feet are arranged at the opposite ends of the side structure base and can be adjusted to raise the side structure and, therewith, the entire furniture structure from the supporting plane, compensating construction tolerances or deformations due to the load supported by the furniture structure, or thermal deformations of the furniture structure.

7. The furniture structure according to claim 1, wherein the side structure comprises at least one series of anchoring means of support hooks for shelves, and/or wherein
said anchoring means comprise a rack received in a track of the side structure and facing with its anchoring loops a track slot, through which support hooks for shelves are inserted and are coupled with said anchoring loops to support a shelf at the preset height, and/or wherein
a pair of opposite side structures clamped by a back panel and a base structure form a structure of a bookcase to which a plurality of shelves or ledges are coupled, and/or wherein
said back panel is made of steel plate having a thickness ranging from between 1 mm and 4 mm, preferably 2 mm, and/or wherein
said retaining block is made of steel and forms a block seat having a height ranging from between 20 mm and 700 mm, preferably 30 and 100 mm, to receive in undercut the tenon projection of the back panel.

8. A method of assembling a furniture structure, comprising the steps of:
providing a furniture structure according to claim 1,
vertically arranging a side structure that is rested on a supporting plane;
fitting a back panel tenon in undercut in a side structure slit;
at least partially inserting a back panel edge in a side structure slit.

9. The method of assembling a furniture structure according to claim 8, comprising the further steps of:
arranging a second opposite side structure facing the first one, and
fitting in undercut an opposite back panel tenon provided at the opposite end of the back panel in a side structure slit of the opposite side structure, and
at least partially inserting an opposite back panel edge in an opposite side structure slit of the opposite side structure, and/or comprising the further steps of,
before fitting in undercut the opposite back panel tenon in the side structure slit of the opposite side structure, connecting a base structure to the base of the first side structure, tightening and closely pressing the back panel, and/or comprising the further optional steps of
connecting the opposite side structure to the opposite end of the base structure, and resting a cover structure on the opposite side structures by fitting the longitudinal cover seat on the back panel edge.

10. The method of assembling a furniture structure according to claim 9, comprising the further steps of
inserting the at least one coupling pin and the undercut supporting washer projecting from the rear part of a decorative panel into an inlet opening seat of a seat for decorative panel provided in an end side structure of a furniture structure,
coupling in undercut of the wall of a side structure body the supporting washer by sliding the stem of the coupling pin along the panel coupling slit,
embedding the decorative panel in the embedding seat of the side structure, and/or comprising the further optional steps of
inserting the at least one coupling pin and the undercut supporting washer projecting from the rear part of a decorative panel into an inlet opening seat of a seat provided for in a cover structure of a furniture structure, coupling in undercut of the wall of a cover structure body the supporting washer by sliding the coupling pin stem along the panel coupling slit, embedding the decorative panel into the embedding seat of the cover structure.
